(19) United States
(12) Patent Application Publication
(10) Pub. No.: US 2006/0015343 A1
(43) Pub. Date: Jan. 19, 2006

(54) Identifying phonetically irregular words

(76) Inventor: Sharon Sue Talmadge, San Marcos, CA (US)

Correspondence Address: FISH & RICHARDSON, PC, P.O. BOX 1022, MINNEAPOLIS, MN, 55440-1022, US

(21) Appl. No.: 11/184,508

(22) Filed: Jul. 18, 2005

Related U.S. Application Data
(60) Provisional application No. 60/589,424, filed on Jul. 19, 2004.

(51) Int. Cl. G10L 13/00

(52) U.S. Cl. 704/260

(57) ABSTRACT

A technique is described that identifies at least one phonetically irregular word in a text passage and displays the identified at least one phonetically irregular word in a readable format different from other portions of the text passage. Related apparatuses, techniques, systems, computer program products are also described.

### CLAIM OF PRIORITY

This application claims priority from U.S. Pat. No. 60/589,424 entitled “Method and Apparatus to Assist in the Identification of Sight Words,” filed Jul. 19, 2004, the contents of which are hereby fully incorporated by reference.

### TECHNICAL FIELD

The subject matter described herein relates to the identification of phonetically irregular words to facilitate, for example, pronunciation of such phonetically irregular words.

### BACKGROUND

Language teachers have long noted the difficulties posed by words and other letter combinations that contain or create unexpected sounds. Some of these words or letter combinations are so common that they present significant barriers to individuals first learning to read or learning a new language. Phonetically irregular words are words or letter combinations that are difficult to read, pronounce, or write because they do not follow regular phonics or spelling rules. Phonetically irregular words may not be sounded out using regular phonetic rules, making them especially difficult for language learners. Another category of words long noted by educators to be important for language learners is called “sight words.” Sight words are words used so commonly that most educators believe they should be recognized instantly by sight, rather than as strings of letters for phonetic treatment.

As teachers of reading and writing have come to appreciate the importance of phonics—that is, learning the sounds of words and letters—they have sought improved, phonics-based tools for teaching language to child and adult learners. As useful as phonics are, however, they cannot help a beginning reader confronted by phonetically irregular words.

So, while there is general recognition of the importance and difficulty of phonetically irregular words when teaching language arts, few strategies have been offered to enable students to effectively identify, pronounce, and learn phonetically irregular words in meaningful text.

### SUMMARY

In one aspect, at least one phonetically irregular word in a text passage may be identified. In addition, the identified at least one phonetically irregular word may be displayed in a readable format different from other portions of the text passage.

An identified phonetically irregular word may, for example, be displayed with a readable format such as a bolded or italicized font, highlighted or underlined text, capitalized text, small capitalized text, increased or decreased font size, modified text color, a polygon enclosing the at least one identified phonetically irregular word, or a raised text, Braille, or other format with a tactile component suitable for sight impaired persons. Combinations of one or more of these markings may be also be utilized. Optionally, only a first instance of the phonetically irregular word may be displayed in a readable format different from other portions of the text passage.

In some variations, the identified at least one phonetically irregular word may be linked to a document displaying additional information, such as a phonetic representation of the at least one phonetically irregular word. Such additional information may be displayed or conveyed in response to the activation of a graphical user interface element (e.g., mouse selecting a highlighted phonetically irregular word, etc.). In other variations, an audible pronunciation of the identified at least one phonetically irregular word may be produced. For example, the identified at least one phonetically irregular word may be linked to an audio file containing audible pronunciations of the identified at least one phonetically irregular word.

Each word in the text passage may be compared with a list of phonetically irregular words stored in a data repository and/or in cache. The phonetically irregular words may comprise at least a portion of The Reading Teacher's Book of Lists, List 11 Phonetically Irregular Words. Optionally or in addition, the text passage may be compared with a list of sight words stored in a data repository and/or cache. Such sight words may comprise at least a portion of Fry's instant phonetically irregular words. In some variations, not every phonetically irregular word identified is displayed in a readable format different from other portions of the text passage. That is, it may be advantageous to draw the reader's attention only to certain phonetically irregular words appearing in a text passage rather than all phonetically irregular words appearing in a text passage. Such an arrangement may be particularly helpful in progressively identifying more complex phonetically irregular words. In addition or in the alternative, the identified at least one phonetically irregular word may be appended or otherwise associated to the text passage. The at least one identified phonetically irregular word may also be stored in a data repository.

In another aspect, an apparatus may comprise an identification unit to identify at least one phonetically irregular word in a text passage, and a display unit to display the identified at least one phonetically irregular word in a readable format different from other portions of the text passage. The apparatus may also include or be coupled to a data repository. The data repository may store a list of phonetically irregular words and periodically provide the identification unit with a list of such phonetically irregular words and/or respond to periodic polling from the identification unit to determine whether a currently considered word constitutes a phonetically irregular word.

In other variations, the display unit links the identified at least one phonetically irregular word to a document displaying a phonetic representation of the identified at least one phonetically irregular word. The apparatus may additionally or alternatively include an audio speaker for conveying an audible pronunciation of the identified at least one phonetically irregular word.

In yet other variations, the display unit may include a graphical user interface unit providing at least one graphical user interface element associated with the at least one identified phonetically irregular word that displays additional information associated with the at least one identified phonetically irregular word when activated.

Computer-program products, which may be embodied on computer-readable material, are also described. Such computer-program products may include executable instructions that cause a computer system to conduct one or more of the method acts described herein.

Similarly, systems are also described that may include a processor and a memory coupled to the processor. The memory may encode one or more programs that cause the processor to perform one or more of the method acts described herein.

The subject matter described herein provides many advantages. For example, users may advance more rapidly than those using conventional language learning systems with minimal additional training costs, greater simplicity, and increased user satisfaction. Moreover, the current subject matter can be used to readily provide metrics regarding the progress of a student or other learner. The details of one or more variations of the subject matter described herein are set forth in the accompanying drawings and the description below. Other features and advantages of the subject matter described herein will be apparent from the description and drawings and from the claims.

### DESCRIPTION OF DRAWINGS

FIG. 1 is a process flow diagram illustrating a method for identifying and displaying phonetically irregular words in a text passage;

FIG. 2 is a schematic diagram of an apparatus to identify and display phonetically irregular words in a text passage;

FIG. 3 is a passage from a children's book with phonetically irregular words marked;

FIG. 4 is a list of selected phonetically irregular words;

FIGS. 5A-5C are lists of selected sight words; and

FIG. 6 is a process flow diagram of a method for identifying phonetically irregular words in a text passage.

### DETAILED DESCRIPTION

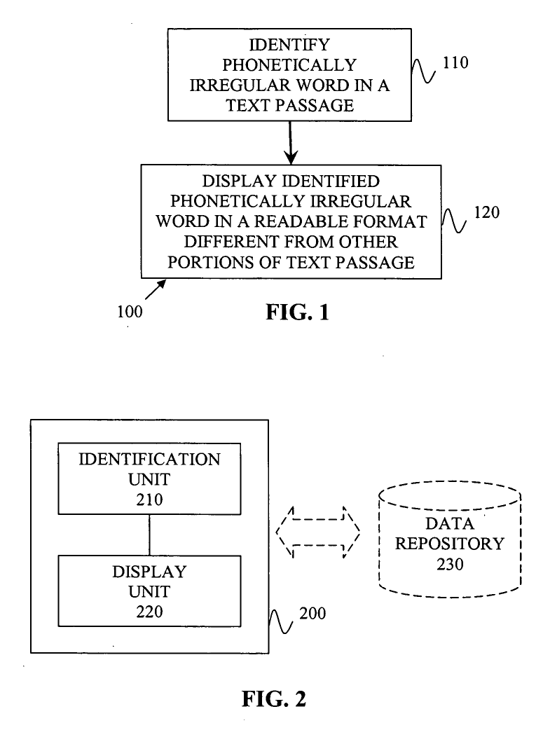

FIG. 1 is a process flow diagram illustrating a method 100 that, at 110, identifies at least one phonetically irregular word in a text passage. Once this identification has been made, at 120, the identified at least one phonetically irregular word is displayed in a readable (e.g., visual, tactile, etc.) format different from other portions of the text passage.

FIG. 2 illustrates an apparatus 200 comprising an identification unit 210 and a display unit 220. The identification unit 210 is operable to identify at least one phonetically irregular word in a text passage. The display unit 220 is operable to display the text passage such that the identified at least one phonetically irregular word is displayed in a readable format different from other portions of the text passage. In some variations, the apparatus 200 may be coupled to or include a data repository 230 for storing a list of phonetically irregular words.

The following provides information useful for understanding and implementing the subject matter described herein as well as optional variations that may be implemented singly or in combination depending on the desired configuration.

As used herein, the term phonetically irregular words refers to any word that is difficult to pronounce by sounding out its letters. Moreover, the term phonetically irregular words as used herein may also include words that are not phonetically pronounced (e.g., phonetically irregular word/letter combinations). The term text passage may relate to any format in which text may be presented or stored, including electronic documents such as word processing files, data containing text or capable of being converted into text, printed documents, web pages, and the like.

By displaying the at least one identified phonetically irregular word in a different format, readers of the displayed information is clearly notified that they should pay special attention to the phonetically irregular words. The displayed at least one identified phonetically irregular word may be modified in any fashion provided that it may be distinguished from other words or elements in the text passage. For example, the identified at least one phonetically irregular word may be altered to include one or more of the following: bold type; italicized type; type in a different font; type in a different color; underlined text; highlighted text; graphical indicators including a polygon enclosing the phonetically irregular word; or a raised text, Braille, or other format with a tactile component suitable for sight impaired persons.

In some variations, the displayed identified at least one phonetically irregular word may be linked (e.g., hyperlinked) or otherwise associated with additional information regarding the phonetically irregular word. For example, by using an input device, such as a mouse, a user may select or activate the link so that the additional information is displayed or conveyed to the user. The additional information may include a dictionary respelling or phonetic representation (or other representation to facilitate pronunciation) of the identified at least one phonetically irregular word, playing an audio file containing a proper pronunciation of the identified at least one phonetically irregular word, and the like. The additional information may be conveyed in a pop up window or text box, a webpage, through audio speakers, as well as via other mechanisms.

In some variations, the identified at least one phonetically irregular word may be stored in data repository such as a database and/or appended to the end of the passage of text. This list (whether stored in the data repository or appended to the passage of text) may be used to generate lists of phonetically irregular words for use as a study aid as well as other purposes.

The text passage containing the identified at least one phonetically irregular word in a different readable format may also be used in connection with a handheld scanning device. Such a device may contain an optical scanner, which may be moved across the text passage. As the device encountered phonetically irregular words, it may identify them, put them in the device's memory, and display a phonetic spelling of the identified phonetically irregular words in a graphical user interface. Alternatively, the device may contain a speaker that provides an audible pronunciation of the identified phonetically irregular words at the reader's command.

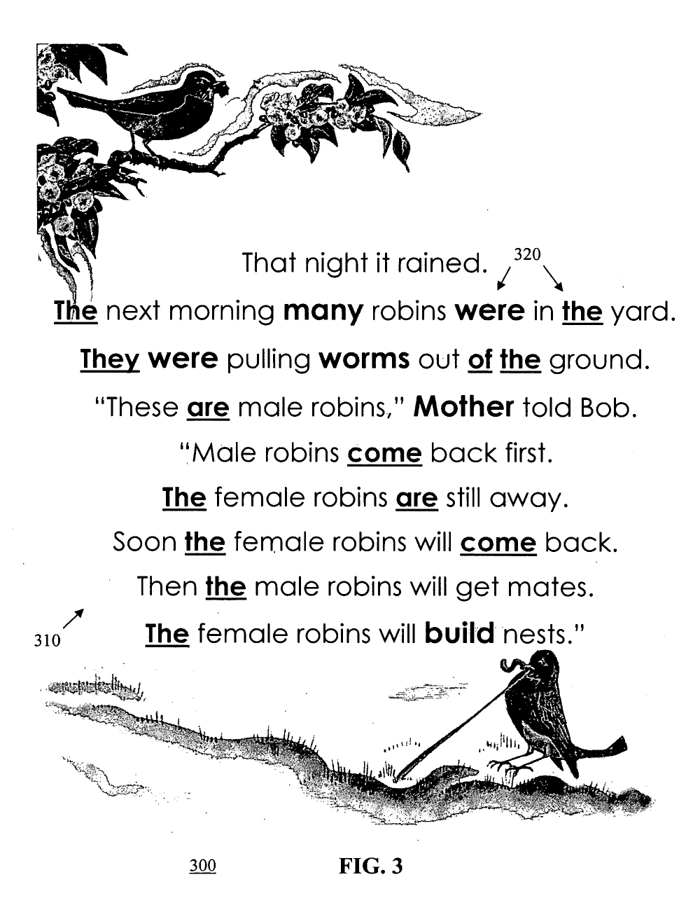

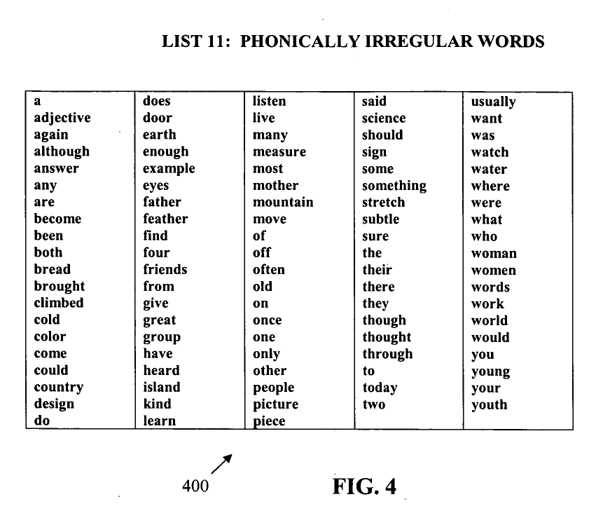

FIG. 3 illustrates a page 300 including a sample passage 310 from a children's text that has had phonetically irregular words 320 marked. In this example, the marked words are in bold type and are readily recognized by the reader, even a beginning reader, and can be more easily selected for special treatment. For example, the user may consult an accompanying index or guidebook that contains phonetic spellings of the marked words.

In addition or in the alternative, the phonetically irregular words may be marked with, for example, underlining or enlarged font (in addition to the bold type) to indicate various levels of difficulty. In sample page 300, the underlining indicates those phonetically irregular words that a beginning learner needs to know. The enlarged font indicates a word that an intermediate learner needs to know. In addition or in the alternative, the user may enter the marked words into a computer, for example, and use software or the Internet to produce an audible pronunciation of the words. In addition or in the alternative, the user may apply a hand-held device such as an optical scanner to the marked words. The hand-held device may store the words and display phonetic spellings of the phonetically irregular words in response to the scanning. Alternatively, the hand-held device may provide an audible pronunciation of the phonetically irregular words.

FIG. 4 illustrates a sample list 400 of phonetically irregular words, based on Reading Teacher's Book of Lists, List 11 Phonically (i.e., phonetically) Irregular Words. This list 400 is by no means exhaustive and represents a sample collection of phonetically irregular words that might be presented to a grade school student.

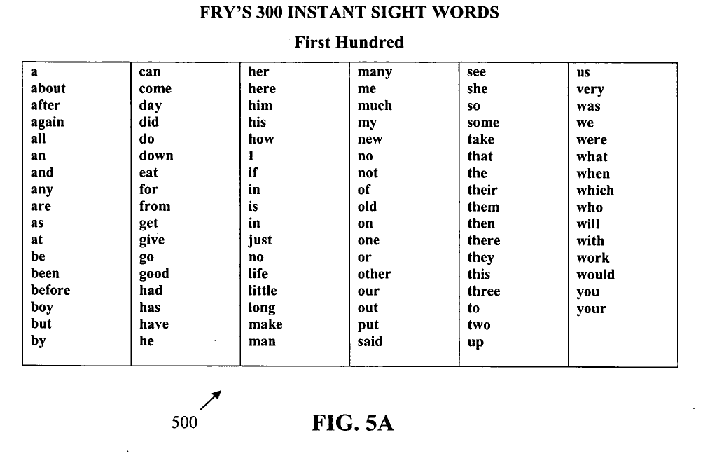

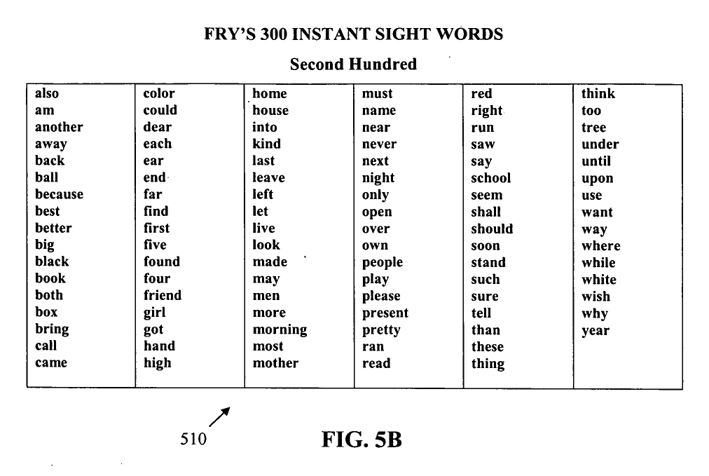

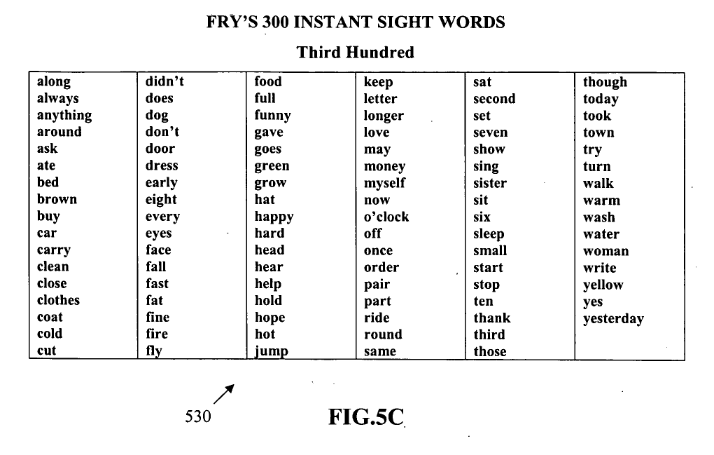

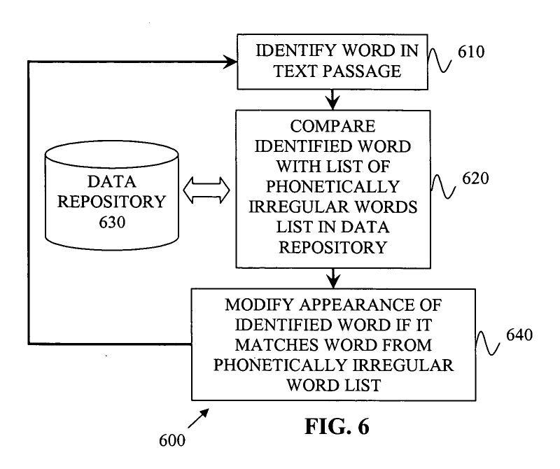

FIG. 5A-5C provide sample lists 500, 510, 520 of sights words, some of which may comprise phonetically irregular words. These lists are not exhaustive; many more such sight words exist. FIG. 5A-C provides three different lists 500, 510, 520, divided according to the skill level or age of the user. The First Hundred sight words list 500 represents those that someone in the earliest stages of language learning should know. The Second Hundred sight words list 510 represents those words that someone who had learned some sight words should attempt to master next. The Third Hundred sight words list 520 represents those sight word that a more advanced learner should attempt to learn or memorize. In some variations, only a portion of available sight words and/or phonetically irregular words may be displayed. For example, for an advanced beginner, sight words from the Third Hundred sight words list 520 may be displayed in a different readable format than sight words in from the Second Hundred sight words list 510. Similar differentiation may be provided with phonetically irregular words.

Alternatively, phonetically irregular words in each of the different categories may be displayed in a different readable format to indicate which phonetically irregular words are for novices and which are for more advanced learners. Similarly, the analysis, marking, and display units may identify or analyze, mark, and display phonetically irregular words from these various lists in a manner that allows a user to identify a phonetically irregular word as being, for example, a First-, Second-, or Third-Hundred phonetically irregular word.

FIG. 6 is a diagram illustrating a process 600, which at 610, identifies a word in a text passage. Thereafter, at 620, the identified word is compared with a phonetically irregular word list in a data repository 630. If there is a match of the identified word from the list in the data repository 630 (or cached in memory, etc.), then at 640, the appearance of the identified word is modified (i.e., the appearance is altered to distinguish it from other non-phonetically irregular words in the text passage). In some variations, the process 600 may be utilized to analyze each word as it is entered into a word processor. If a phonetically irregular word is entered, the appearance of the phonetically irregular word may be altered as compared to non-phonetically irregular words (similar to the designations associated with misspelled words in MS Word). Alternatively, the process 600 may be applied on a word-by-word basis to a pre-existing text passage.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

I claim:

1. A method comprising:
identifying at least one phonetically irregular word in a text passage; and
displaying the identified at least one phonetically irregular word in a readable format different from other portions of the text passage.

2. A method as in claim 1, wherein the readable format is selected from a group comprising: emboldened font, italicized font, highlighted text, underlined text, capitalized text, small capitalized text, increased or decreased font size, modified text color, a polygon enclosing the at least one phonetically irregular word, and a font with a tactile component.

3. A method as in claim 1, further comprising linking the identified at least one phonetically irregular word to a document displaying a phonetic representation of the identified at least one phonetically irregular word.

4. A method as in claim 1, further comprising producing an audible pronunciation of the identified at least one phonetically irregular word.

5. A method as in claim 1, further comprising linking the identified at least one phonetically irregular word to an audio file containing audible pronunciation of the identified at least one phonetically irregular word.

6. A method as in claim 1, further comprising displaying additional information associated with the at least one identified phonetically irregular word when a graphical user interface element associated with the at least one identified phonetically irregular word is activated.

7. A method as in claim 1, wherein the identifying at least one phonetically irregular word in a text passage comprises: comparing each word in the text passage with a list of phonetically irregular words stored in a data repository.

8. A method as in claim 1, further comprising: appending the identified at least one phonetically irregular word after the text passage.

9. A method as in claim 1, wherein the identifying at least one phonetically irregular word in a text passage identifies only a portion of phonetically irregular words in the text passage.

10. A method as in claim 1, wherein the displaying the identified at least one phonetically irregular word in a readable format different from other portions of the text passage comprises:
displaying, for each phonetically irregular word, only a first instance of the phonetically irregular word in a readable format different from other portions of the text passage.

11. A method as in claim 1, further comprising storing the at least one identified phonetically irregular word in a data repository.

12. A method as in claim 1, wherein there is more than one identified at least one phonetically irregular word, and wherein the displaying of the identified at least one phonetically irregular word in a readable format different from the other portions of the text passage comprises:
displaying a first portion of the at least one phonetically irregular word in a first readable format and displaying a second portion of the at least one phonetically irregular word in a second readable format.

13. An apparatus comprising:
an identification unit to identify at least one phonetically irregular word in a text passage; and
a display unit to display the identified at least one phonetically irregular word in a readable format different from other portions of the text passage.

14. An apparatus as in claim 13, wherein the display unit links the identified at least one phonetically irregular word to a document displaying a phonetic representation of the identified at least one phonetically irregular word.

15. An apparatus as in claim 13, further comprising an audio speaker for conveying an audible pronunciation of the identified at least one phonetically irregular word.

16. An apparatus as in claim 13, wherein the display unit further comprises: a graphical user interface unit providing at least one graphical user interface element associated with the at least one identified phonetically irregular word that displays additional information complementary to the at least one identified phonetically irregular word when activated.

17. An apparatus as in claim 13, further comprising a data repository storing a list of phonetically irregular words, and wherein the identification unit periodically polls the data repository to determine whether a portion of the text passage contains a phonetically irregular word.

18. An apparatus as in claim 13, wherein the identification unit identifies at least one instant phonetically irregular word in the text passage and the display unit displays only a portion of the at least one phonetically irregular words.

19. An apparatus as in claim 13, wherein the display unit displays for each phonetically irregular word only a first instance of the phonetically irregular word in a readable format different from other portions of the text passage.

20. A computer-program product, embodied on computer-readable material, said computer-program product including executable instructions that cause a computer system to conduct one or more of operations comprising:
identifying at least one phonetically irregular word in a text passage; and
displaying the identified at least one phonetically irregular word in a readable format different from other portions of the text passage.
